(19) United States
(12) Patent Application Publication
(10) Pub. No.: US 2006/0239528 A1
(43) Pub. Date: Oct. 26, 2006

(54) Operating method for a computer, operating method for a medical imaging system and items corresponding thereto

(75) Inventors: Estelle Camus, Erlangen (DE); Martin Kleen, Furth (DE); Thomas Redel, Poxdorf (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/408,251

(22) Filed: Apr. 20, 2006

(30) Foreign Application Priority Data
Apr. 20, 2005 (DE) 102005018327.1

(51) Int. Cl. G06K 9/00

(52) U.S. Cl. 382/128

(57) ABSTRACT

A data set describing a vascular system in three dimensions is pre-specified to a computer. A section of the vascular system is selected. With the aid of the data set describing the vascular system in three dimensions, the computer calculates a length of the selected section. A sequence of images of the vascular system is pre-specified to the computer, wherein a time is assigned to each image. One image respectively of the sequence is defined as a start image and as a stop image. With the aid of the length of the selected section and the times assigned to the start image and the stop image, the computer determines a velocity and outputs the velocity together with the selected section to a user. The operating method can be integrated in particular into the clinical workflow.

### CROSS REFERENCE TO RELATED APPLICATIONS

This application claims priority of German application No. 102005018327.1 filed Apr. 20, 2005, which is incorporated by reference herein in its entirety.

### FIELD OF THE INVENTION

The present invention relates to an operating method for a computer, wherein a data set describing a vascular system in three dimensions is pre-specified to the computer.

The present invention further relates to an operating method for a medical imaging system.

The present invention relates furthermore to a data medium comprising a computer program stored on the data medium for implementing an operating method of this type and to a computer comprising such a data medium. The present invention finally relates to a medical imaging system comprising a recording arrangement and a computer of this type such that the medical imaging system can be operated in accordance with such an operating method.

### BACKGROUND OF THE INVENTION

An operating method for a computer, wherein a data set describing a vascular system in three dimensions is pre-specified to the computer, is already known. In this operating method, a section of the vascular system is selected comprising a start and an end, and the computer calculates with the aid of the data set describing the vascular system in three dimensions a length of the selected section. This operating method is used for example to determine the length of stenoses in coronary vessels or in cerebral vessels.

The items of the present invention are used mainly in the field of medical engineering, in particular in angiography where a contrast medium is injected into a patient. With the aid of the distribution of the contrast medium, the perfusion of the coronary vessels and the diameter thereof are determined by a medical professional. The coronary vessels represent in this case the vascular system within the meaning of the present invention.

It has emerged in medical practice that not only the clearance width (=lumen) of the coronary vessels but in particular also the flow velocity of the blood in the coronary vessels is of significance for the diagnosis.

In order to be able to calculate the flow velocity, it goes without saying that the distance covered and the time interval needed for this have to be known. In order to record the time interval which the blood needs in order to flow through a determined section of the coronary vessels, it is known for a sequence of images to be recorded and analyzed which show the entry of the contrast medium into the coronary vessels and its washout from the coronary vessels. According to the scientific article “Coronary and Myocardial Angiography; Angiographic Assessment of Both Epicardial and Myocardial Perfusion” by C. M. Gibson et al., which appeared in Circulation 2004, Volume 109, Issue 25; Jun. 29, 2004, pages 3096 to 3105, the number of images which the contrast medium needs from a start of the determined section to the end thereof is determined for this purpose. The first and the last image then reveal, in conjunction with the image rate (=number of images recorded per second), the time interval sought.

### SUMMARY OF THE INVENTION

However, the flow velocity of the blood cannot yet be determined from this recorded time interval, since the length of the determined section must also be recorded correctly. The establishment of an operating method and of corresponding items by means of which this distance can be determined exactly and correctly is the object of the present invention.

A further object of the present invention consists in improving the recording of the time interval needed and in integrating the operating method according to the invention into the clinical workflow.

The first object is achieved in the operating method according to the claims. Using the procedure according to the invention—as opposed to a determination procedure using one image—the actual length of the section can be determined correctly. With one image, which will always represent a projection, this is in principle impossible, however, as even when the image has been calibrated, geometric contractions occur as a result of the projection from three-dimensional space into the two-dimensional image.

Preferably, at least the start is pre-specified to the computer by a user, as the operating method according to the invention can then be handled in a particularly flexible manner. The end of the selected section, on the other hand, can either be determined automatically by the computer or else pre-specified to the computer by the user.

It is possible for the computer to be purely an analyzing computer that does not execute any control functions. Preferably, however, the computer will be operatively connected to a recording arrangement for recording the vascular system, as it is then possible for the computer to control automatically the recording arrangement in a selection-specific manner based upon the selection of the section or of a vascular area containing the section and/or to specify to the user selection-specific instructions for adjusting the recording arrangement.

For example, a patient whose coronary vessels are to be recorded typically lies on his/her back on a patient bed of the recording arrangement. Depending on which main branch (RCA, LAD, LCX) the selected section lies in or which of these main branches is selected, a specific adjustment of the recording arrangement is then optimal for the main branch concerned. These adjustments can then be carried out automatically by the computer and/or corresponding instructions output to the user. The second object, in particular, namely integrating the operating method according to the invention into the clinical workflow, is achieved by means of this procedure.

Integration into the clinical workflow can be even better achieved by means of the procedure according to the claims.

If the computer determines a color assigned to the velocity that has been determined and represents the selected section in this color on a display device, the information content of the representation can be recorded by the user in a particularly easy-to-understand and intuitive manner.

It is simplest if the start image and the stop image are selected by the user. For example, the computer can first output one image of the sequence to the user via a display device and then give the user the opportunity to select by forward-backward inputs the temporally succeeding or preceding image for outputting via the display device and to select by means of a selection input the currently selected image as the start or stop image. Alternatively, however, it is also possible for the start image and the stop image to be selected automatically by the computer.

It is advantageous, both for the selection of start and stop image by the user and for the selection of start image and stop image by the computer, if the computer determines for each image of the sequence, with the aid of the image concerned, a start cross section, which the contrast medium occupies at the start of the selected section, and an end cross section, which the contrast medium occupies at the end of the selected section, and assigns the start cross section and the end cross section to the images. The start image can then be determined with the aid of the start cross sections and the stop image with the aid of the end cross sections.

For example, the image in the sequence in which the start cross section reaches its maximum for the first time can be selected as the start image. In this case, the start image is thus determined with the aid of the image as of which the start cross section ceases to increase. Alternatively, the image in the sequence as of which the start cross section decreases again can also be selected as the start image. The mean value of these two images can also be used. Furthermore, other types of determination are also possible. Determination of the stop image with the aid of the end cross sections is carried out in a manner analogous to that used for determination of the start image with the aid of the start cross sections.

In order to determine the start cross section and the end cross section, the computer preferably determines start lines and end lines in the images. The start lines cut the vascular system at a right angle at the start of the selected section, the end lines at the end of the selected section. Using this procedure, the determination of start cross section and end cross section takes a particularly simple form.

The data set describing the vascular system in three dimensions consists in the simplest case of a number of projections of the vascular system which are recorded in the same phase of the vascular system. With the heart beating, this can be achieved, for example, by means of an ECG trigger. Alternatively, however, it is also possible for the data set describing the vascular system in three dimensions to be a volumetric data set.

### BRIEF DESCRIPTION OF THE DRAWINGS

Further advantages and details will emerge from the other claims and the description that follows of an exemplary embodiment in relation to the drawings, in which in schematic representation:

FIG. 1 shows a block diagram of a medical imaging system,

FIGS. 2A and 2B show a flow diagram,

FIG. 3 shows a vascular area,

FIGS. 4 to 6 show flow diagrams,

FIG. 7 shows curves of start cross sections and end cross sections and

FIGS. 8A and 8B show a further flow diagram.

### DETAILED DESCRIPTION OF THE INVENTION

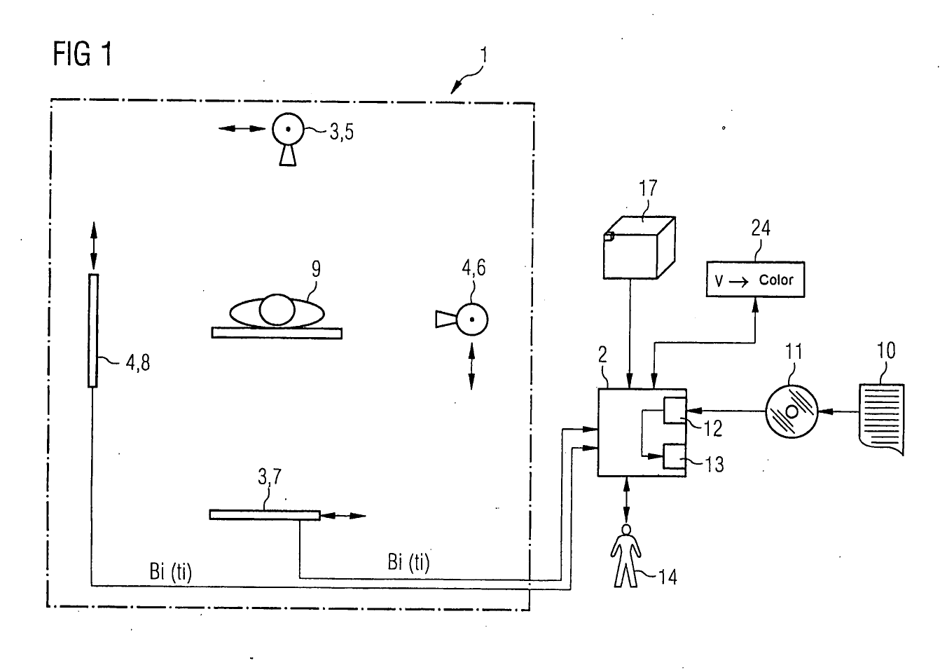

In accordance with FIG. 1, a medical imaging system is fashioned for example as an X-ray system. It comprises a recording arrangement 1 and a computer 2. The computer 2 is operatively connected to the recording arrangement 1.

The recording arrangement 1 comprises in accordance with FIG. 1 a plurality of partial arrangements 3, 4. Each partial arrangement 3, 4 comprises an X-ray source 5, 6 and an X-ray detector 7, 8. Images of an object 9 can be recorded by means of each partial arrangement 3, 4 and transmitted to the computer 2. The X-ray detectors 7, 8 of the partial arrangements 3, 4 record the images of the object 9 from directions of projection that differ from one another.

In a large number of cases, the object 9 is a person, and by means of the partial arrangements 3, 4 a vascular system of the person 9 is recorded, e.g. the blood vessels in the brain of the person 9 or the coronary vessels of the person 9. The present invention is explained in detail below with reference to coronary vessels but is of course not restricted to use with coronary vessels.

A computer program 10 for the computer 2 is stored on a transportable data medium 11. The transportable data medium 11 can for example be a CD-ROM. The transportable data medium 11 comprising the computer program 10 stored thereon is fed into a reading device 12 which is a component of the computer 2. The computer 2 is therefore capable of reading out the computer program 10 and of storing it in a further data medium 13, which is likewise a component of the computer 2. The further data medium 13 is e.g. a hard disk.

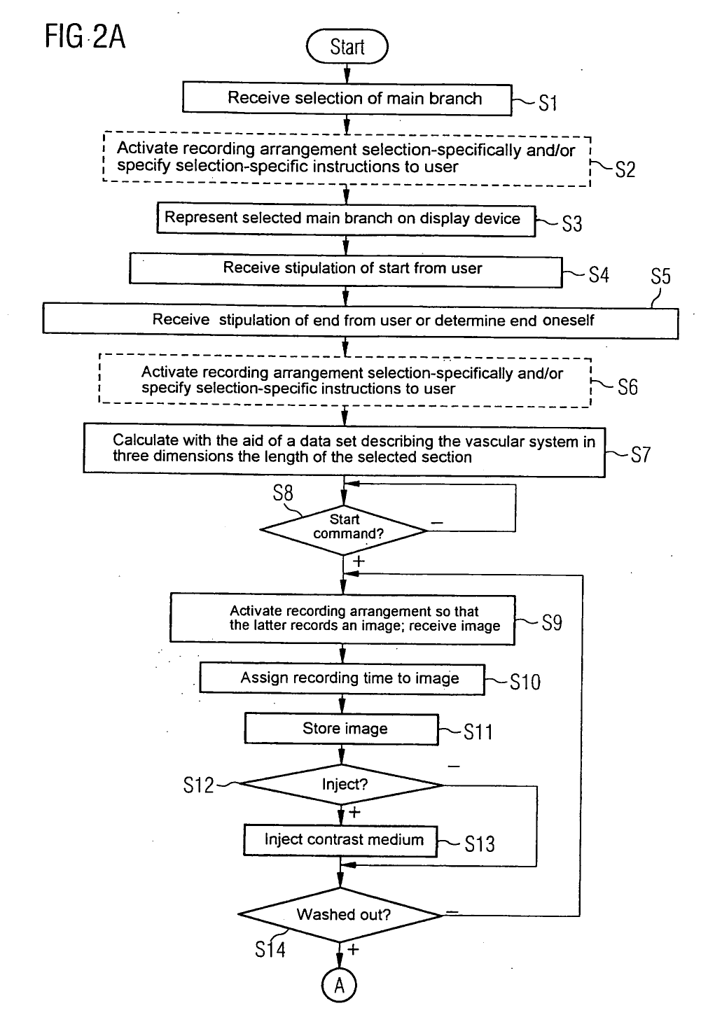

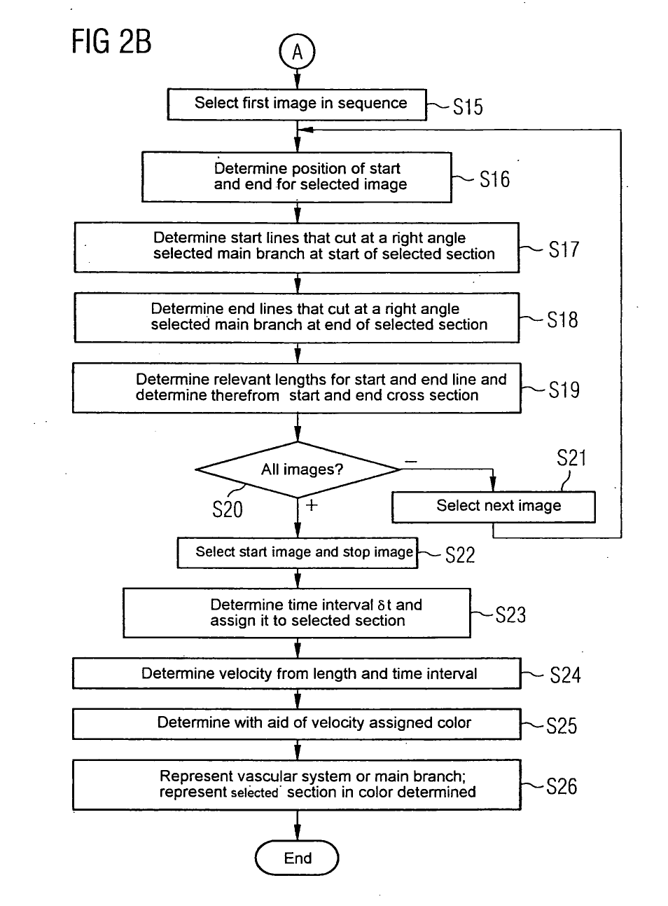

When the computer program 10 is called up, the computer 2 carries out, on the basis of the programming with the computer program 10, an operating method, which is described in detail below in relation to FIGS. 2 to 7.

As is generally known to persons skilled in the art, the coronary vessels of the person 9 have three main branches, which are usually designated by the abbreviations RCA, LAD and LCX. In accordance with FIG. 2 the computer 2 therefore first receives in a step S1 a desired main branch selection, e.g. the main branch RCA.

Depending on the main branch selected, different positionings of the recording arrangement 1 are optimal for the recording of images by the partial arrangements 3, 4. These positionings are previously known and are stored in the computer 2. Based upon the selection of the main branch, the computer 2 therefore controls the recording arrangement 1 preferably in a step S2 automatically in such a manner that the partial arrangements 3, 4 are moved to their optimal positionings for the recording of the selected main branch. This is indicated correspondingly in FIG. 1 by arrows.

As an alternative to automatic control, the computer 2 could also output corresponding instructions for adjustment of the recording arrangement 1 to a user 14. In this case, the user 14 would then have to carry out the corresponding positionings.

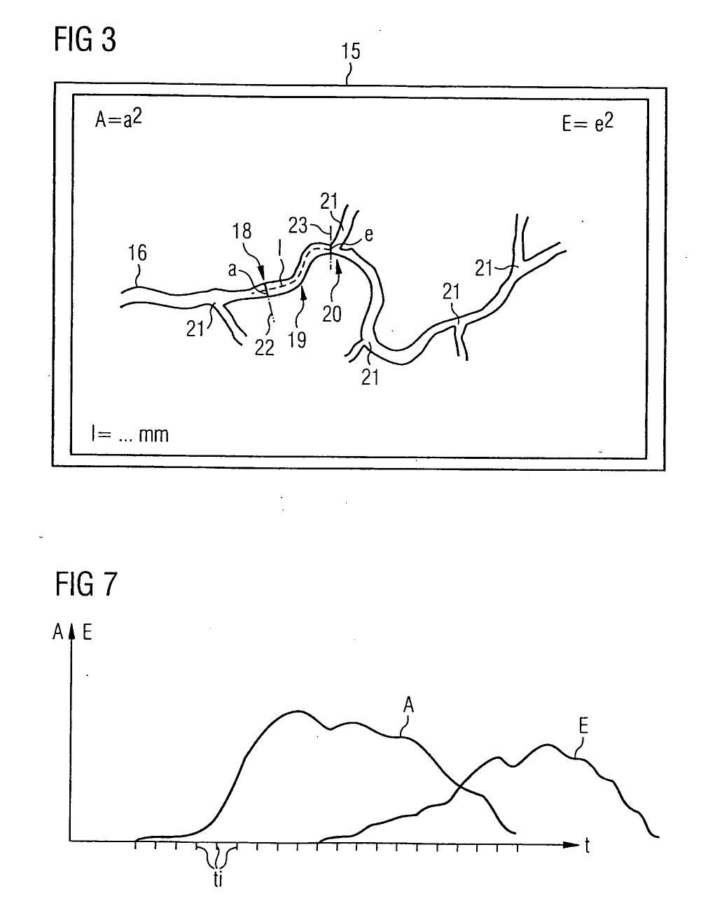

Then, in a step S3, the selected main branch is represented on a display device 15 and thus output to the user 14. FIG. 3 shows an example of a representation of this type. The selected main branch is labeled in FIG. 3 with the reference character 16.

The representation of the main branch 16 can for example be determined with the aid of a current fluoroscopic image by at least one of the partial arrangements 3, 4. It is also possible—see FIG. 1—for a volumetric data set 17 that describes the vascular system to be fed to the computer 2. In this case, the representation of the main branch 16 can be generated with the aid of the volumetric data set 17.

Using the representation of the selected main branch 16—see also FIG. 3 again—a start 18 of a section 19 of the selected main branch 16 is first stipulated in a step S4. This is effected as a rule by means of a corresponding input by the user 14. An end 20 of the section 19 is then determined in a step S5. In the simplest case, the stipulation of the end 20 is also carried out by the user 14. Alternatively, however, it is also possible for the end 20 to be determined automatically by the computer 2. For example, the computer 2 can search the selected main branch 16 for branchings 21 and select as the end 20 e.g. the branching 21 coming first or last, viewed in the direction of blood flow.

After the selection of the section 19 has been made in this manner, it is possible for the computer 2 to activate or reactivate the recording arrangement 1 in a step S6. It is, for example, possible for a readjustment to be made to the positionings of the partial arrangements 3, 4 moved to in step S2. Here, too, it is of course alternatively possible for the computer 2 to activate the recording arrangement 1 automatically or else to output to the user 14 corresponding instructions for adjusting the recording arrangement 1.

Step S6 is only optional and is represented in FIG. 2 only with dashed lines. It could thus also be omitted. Similarly, however, it would also be possible for step S6 to be executed as a replacement for step S2, i.e. for step S2 to be omitted. Step S2 is therefore also represented in FIG. 2 only with dashed lines. This last-mentioned case, i.e. the omission of step S2 coupled with the alternative execution of step S6 may be appropriate in particular where the selection of the section 19 in steps S3 to S5 is made using the volumetric data set 17.

In a step S7, the computer 2 then calculates a length l of the selected section 19. If the volumetric data set 17 is known to the computer 2, this calculation is carried out using the volumetric data set 17. Alternatively, however, a different data set can also be used. For example, by means of the partial arrangements 3, 4 of the recording arrangement 1 images (=projections) of the vascular system can simultaneously be recorded and be analyzed by the computer 2. If the recording arrangement 1 has only a single partial arrangement 3, 4, the individual images can also be recorded in succession. The simultaneity of the recording of the images can in this case, for example, be ensured by a corresponding ECG trigger. What is crucial is that the data set in its entirety describes the vascular system in three dimensions.

In steps S8 to S14, controlled by the computer 2, a sequence of images Bi (i=1, 2, 3, . . . ) is then recorded by the recording arrangement 1 and fed to the computer 2. The recording of the images Bi is carried out, as a rule, at a high image rate of e.g. 25 to 30 images per second. The sequence of images Bi preferably shows the entry of a contrast medium into the selected section 19 and/or the washout of the contrast medium from the selected section 19.

For implementation, in accordance with step S8 a start command is first awaited by the computer 2. If the start command is fed to the computer 2—preferably by the user 14—at least one of the partial arrangements 3, 4 records in step S9 an image Bi and feeds it to the computer 2. The computer 2 assigns the respective recording time ti (i=1, 2, 3, . . . ) to the images Bi in step S10 and stores the images Bi in step S11.

In step S12, the computer 2 checks whether the contrast medium is to be injected. If this is the case, the contrast medium is injected in step S13. In step S14, the computer 2 checks whether the contrast medium is washed out. This check can be carried out, for example, using a time flow or a corresponding input by the user 14. If the contrast medium is not yet washed out, you return to step S9. Otherwise, the operating method according to the invention is continued by means of steps S15 to S21.

In steps S15 to S21, the computer 2 determines for each image Bi in the sequence, with the aid of the image Bi concerned, a start cross section A and an end cross section E. The start cross section A is the cross section which the contrast medium occupies at the start 18 of section 19 of the respective image Bi. The end cross section E is the cross section which the contrast medium occupies at the end 20 of the section 19 of the respective image Bi. Determination of the cross sections A, E is carried out as follows:

Firstly, in step S15, the first image B1 of the sequence is selected. For this image B1, in step S16, the position of the start 18 and of the end 20 of the selected section 19 are firstly determined. This is necessary where the heart is beating, because the position of the coronary vessels changes with the heartbeat. The methods required for determining the position of the start 18 and of the end 20 (so-called tracking methods) are known in the art and do not therefore need to be explained in detail below.

In step S17, the computer 2 then determines—see also FIG. 3—a start line 22, which cuts at a right angle the selected main branch 16 at the start 18 of the selected section 19. To determine the start line 22, the direction of the selected main branch 16 at the start 18 of the selected section 19 can be determined e.g. in a manner known in the art in the currently selected image Bi, here the image B1, and the line 22 perpendicular hereto used.

In an analogous manner, in step S18 an end line 23 is determined which cuts at a right angle the selected main branch 16 at the end 20 of the selected section 19.

In step S19, the computer 2 determines for the start line 22 and the end line 23 of the currently selected image Bi, here the image B1, lengths a, e, within which in the currently selected image Bi a defined limit is exceeded. These lengths a, e are deemed to be filled with contrast medium. The squares of the lengths a, e then correspond to the start cross section A or the end cross section E, which the computer 2 assigns to the respective image Bi.

The start cross section A of the currently selected image Bi is thus determined using the respective start line 22, and the end cross section E using the respective end line 23.

The limit above which the respective vessel is assumed to be filled with contrast medium can in principle be chosen freely. Preferably, the limit for the start lines 22 is determined independently of the limit for the end lines 23. For example, the maximum of all the grey values can be determined which, viewed over all the images Bi of the sequence, is achieved on the start line 22, and a fixed percentage of this maximum value used as a limit for the start lines 22. An analogous situation applies to the end lines 23.

In step S20, the computer 2 checks whether it has already performed steps S16 to S19 for all the images Bi of the sequence. If this is not yet the case, the computer 2 selects in step S21 the next image Bi and then jumps back to step S16.

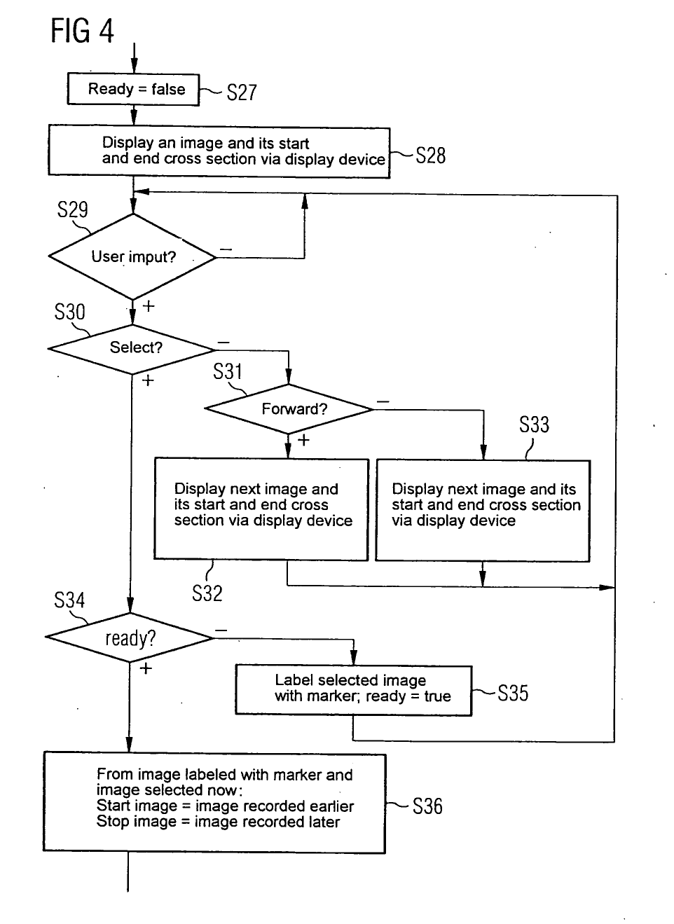

If, on the other hand, the determination of cross sections A, E has already taken place for all the images Bi of the sequence, the computer 2 passes to a step S22. In step S22, one image Bi of the sequence is defined as a start image and another image Bi of the sequence as a stop image. This step S22 will be examined in closer detail later in relation to FIGS. 4 to 6.

By defining the start image and the stop image, corresponding times are also determined. The computer 2 is therefore capable in a step S23 of determining the difference between these times as a time interval δt and of assigning it to the selected section 19. In a step S24, the computer 2 can then also determine from the length l of the selected section 19 determined in step S7 and the time interval δt determined in step S23 a velocity v with which the blood flows in the selected section 19.

In a step S25, the computer 2 then determines with the aid of a look-up table 24 or such like a color that is assigned to the determined velocity v, and assigns it to the selected section 19. This assignment can alternatively be effected in the two-dimensional images Bi or in a three-dimensional volumetric data set, e.g. the volumetric data set 17. The phase position of the heart in the volumetric data set and the phase position of the heart in the two-dimensional images Bi should correspond to one another here.

In a step S26, the computer 2 finally represents the vascular system or the selected main branch 16. The selected section 19 is represented in the color which was determined previously by the computer 2 in step S25. As a result, the computer 2 therefore outputs the section 19 and the determined velocity v together to the user 14.

The meaning and purpose of the assignment, described in connection with steps S15 to S21, of the start cross section A and of the end cross section E to the images Bi is to be able to determine the correct start image and the correct stop image. The start image should thus be determined with the aid of the start cross section A and the stop image with the aid of the end cross section E. This applies irrespective of whether the start image and the stop image are selected by the user 14 or are selected automatically by the computer 2.

If the start image and the stop image are selected by the user 14, this is preferably carried out as shown in FIG. 4 as follows:

Firstly, in a step S27, the computer 2 sets a logic variable ready to the value “false”. The computer 2 then extracts in a step S28 a random image Bi of the sequence and displays this image Bi, as well as its start cross section A and its end cross section E, via the display device 15. For example, the first image B1 of the sequence can be output to the user 14. The computer 2 then waits in a step S29 for an input by the user 14.

When the input by the user 14 has been made, the computer 2 checks in a step S30 whether the input was a selection command. If this is not the case, the computer 2 checks in a step S31 whether the input was a command to page forward in the sequence of images Bi. If this is the case, the computer 2 selects in a step S32 the temporally next image Bi and outputs this image Bi together with the assigned cross sections A, E via the display device 15 to the user 14. Otherwise, the computer 2 selects in a step S33 the temporally preceding image Bi and outputs it together with the assigned cross sections A, E via the display device 15 to the user 14. Irrespective of which of the two steps S32 and S33 was executed, the computer 2 then goes back to step S29.

If, on the other hand, the input by the user 14 in step S29 was a selection command, the computer 2 branches from step S30 to a step S34. There, the computer 2 checks whether the logic variable ready has the value “true”. If this is not the case, in a step S35 the currently displayed image Bi is labeled with a marker by the computer 2 and the logic variable ready is set to the value “true”. The computer then goes back to step S29.

If, on the other hand, the check in step S34 produced the result that the logic variable ready already has the value “true”, the present selection of an image Bi is already the second “final” selection that the user 14 has undertaken. The computer 2 therefore branches to a step S36. In step S36, the computer 2 checks whether the image Bi labeled with the marker or the image Bi now selected by the user 14 is the earlier recorded image Bi. It determines the earlier recorded image Bi as the start image and the other image Bi as the stop image.

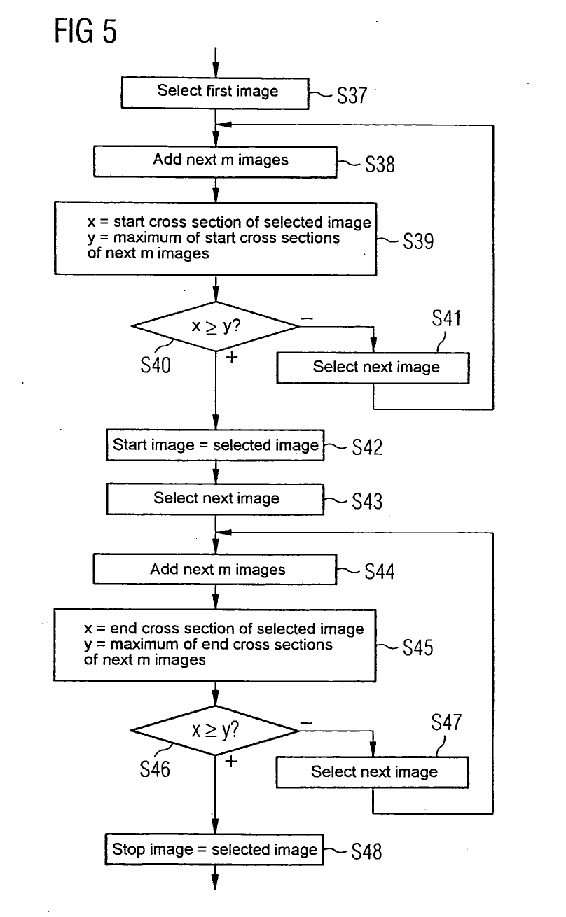

If the computer 2 determines the start image and the stop image automatically, this can be done as explained in detail below in relation to FIG. 5.

As shown in FIG. 5, the computer 2 first selects in a step S37 the first image B1 of the sequence. It then adds in a step S38 the next m (m=1, 2, . . . ) images Bi.

In a step S39, the computer 2 determines two auxiliary variables x, y. The auxiliary variable x is equated to the start cross section A of the currently selected image Bi. The auxiliary variable y is equated to the maximum of the start cross sections A of the m added images Bi.

In a step S40, the computer 2 checks whether the auxiliary variable x is greater than or equal to the auxiliary variable y. If this is not the case, the computer 2 selects in a step S41 the next image Bi and goes back to step S38. Otherwise, the computer 2 has found the start image, which is why in a step S42 it defines the currently selected image Bi as the start image.

In steps S43 to S48, an analogous procedure is carried out with regard to the end cross sections E. By means of this procedure, the stop image is determined as a result. Thus, as a result, by means of the procedure shown in FIG. 5 the start image is determined with the aid of the image Bi as of which the start cross section A ceases to increase. The stop image is determined as the image Bi as of which the end cross section E ceases to increase.

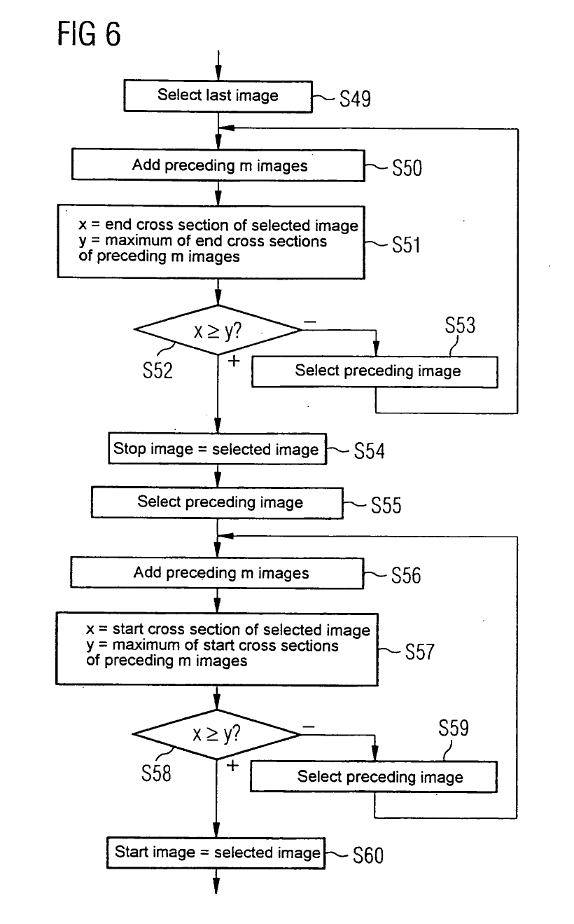

The procedure shown in FIG. 6 with its steps S49 to S60 is the inverse of the procedure shown in FIG. 5 as, in contrast to FIG. 5, in FIG. 6 the start image is determined with the aid of the image Bi as of which the start cross section A decreases again. Likewise, the stop image is determined with the aid of the image Bi as of which the end cross section E decreases again. In other respects, the representation shown in FIG. 6 is self-explanatory so that detailed explanations of steps S49 to S60 are dispensed with below.

Other procedures are also possible. For example, the procedures shown in FIGS. 5 and 6 can be combined with one another and the respective mean values used as a final result for the start image or for the stop image.

It is furthermore also possible—see FIG. 7—to create and display curves of the start cross sections A and of the end cross sections E over time. This is appropriate in particular where the user 14 determines the start image and the stop image himself/herself.

The reliability of the analysis of the sequence of images Bi, i.e. the accuracy in determining the start image and the stop image, can be further improved if, prior to the procedure according to FIGS. 5 to 7, the cross sections A, E are equalized. For example, a weighted mean value can be generated.

The recording of the sequence of images Bi and the processing of the sequence of images Bi can be decoupled from one another. The computer 2 which interacts with the recording arrangement 1 and records the images Bi does not therefore have to be identical to the computer 2 that analyzes the recorded images Bi and the data set describing the vascular system in three dimensions. As a rule, however, this will be the case. Furthermore, the operating method according to the invention is also not restricted to the analysis of a single selected section 19. It may possibly be much more appropriate to define multiple sections 19 of this type. The sections 19 can be adjacent to one another or be separate from one another.

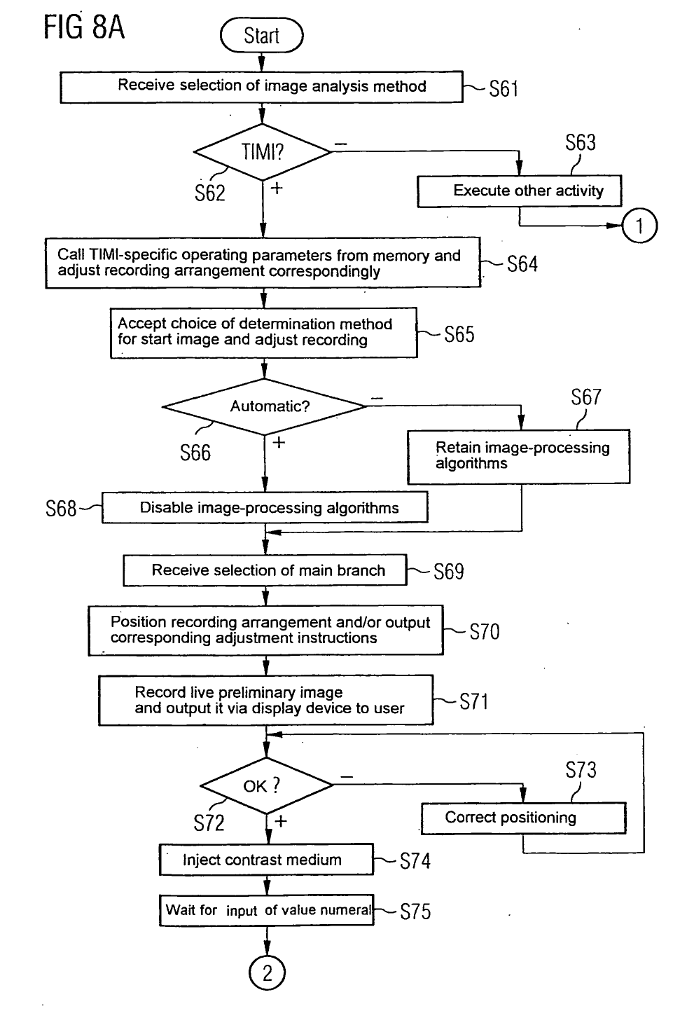

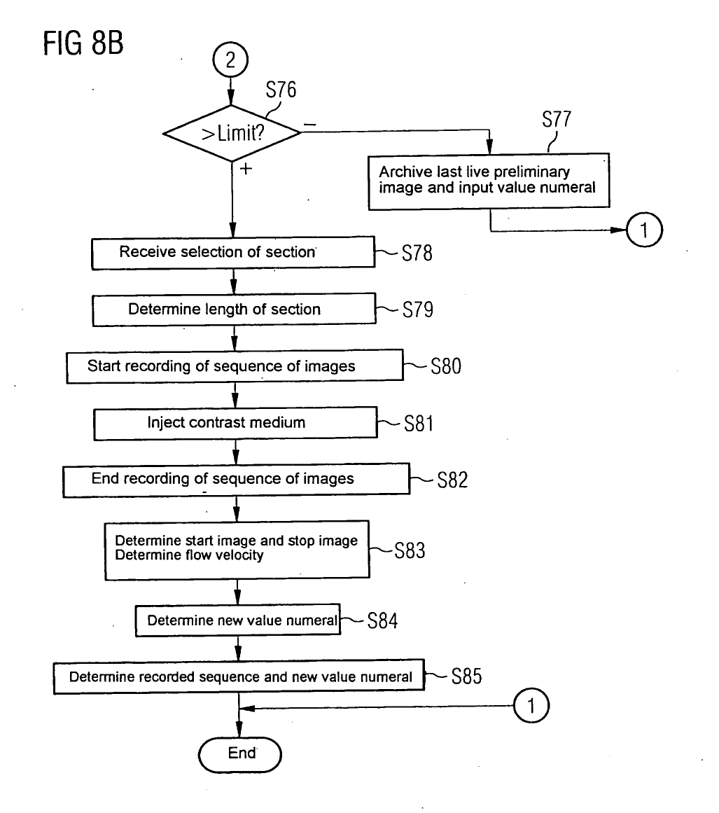

For the recording of the sequence of images Bi, it is even possible to adapt the operation of the medical imaging system largely automatically to the image analysis method according to the invention. This is explained in detail below in relation to FIG. 8. The remarks relating to FIG. 8 are of course possible only if the computer 2 is configured as a control device 2 of the medical imaging system. The analysis of the recorded images Bi, by contrast, does not have to be carried out by this computer 2, even if this is of course possible. Where the analysis of the recorded images Bi is also dealt with below in relation to FIG. 8, this analysis is therefore only optional.

According to FIG. 8, the control device 2 first receives in a step S61 from the user 14 a selection of an image analysis method. In a step S62, the control device 2 then checks whether the method according to the invention, described hereinabove in relation to FIGS. 1 to 7, is to be executed. If this is not the case, the control device 2 executes in a step S63 a different activity, e.g. a live fluoroscopy or an image acquisition for a later 3D-reconstruction of an—in principle random—object.

If, on the other hand, in step S61 the inventive method was selected, the control device 2 retrieves operating parameters from a memory assigned to it, in a step S64, and adjusts the recording arrangement 1 automatically according to the operating parameters retrieved. The operating parameters are independent of the positioning of the recording arrangement 1.

For example, the operating parameters may comprise current intensities and/or voltages with which the X-ray sources 5, 6 are to be operated, and/or image rates with which the X-ray detectors 7, 8 are to record images. For example, in the case of the automated injection of a contrast medium, the total quantity of contrast medium and/or the quantity of contrast medium per second can also be adjusted. The values of the operating parameters to be adjusted can either be stipulated by the manufacturer of the medical imaging system or of the control device 2 or else by the user 14.

Then, in a step S65, the control device 2 receives a selection of the selection method for determining start image and stop image and reviews this selection in a step S66. If in step S65 an interactive determination by the user 14 was selected, image-processing algorithms which are usually executed are retained in accordance with a step S67. If, on the other hand, an automatic determination of start image and stop image was selected by the control device 2, the image-processing algorithms are disabled in a step S68. Optionally, however, they could also be partially retained within the framework of step S68. As part of the selection of the image analysis method, the user 14 therefore also stipulates whether the selection of the start image and of the stop image is carried out by the user 14 or by the control device 2. The control device 2 then varies the positioning-independent image parameters of the recording arrangement 1 in accordance with this selection.

The control device 2 then receives in a step S69 from the user 14 a selection of a main branch 16. In a step S70, it then positions automatically the recording arrangement 1 and/or outputs automatically corresponding adjustment instructions to the user 14. In a step S71, the control device 2 activates the recording arrangement 1 such that this recording arrangement records a live image of the vascular system. The control device 2 outputs this image—still in step S71—via the display device 15 to the user 14.

In a step S72, the control device 2 waits for a confirmation from the user 14. If the control device 2 does not receive this confirmation, the positioning of the recording arrangement 1 is corrected in a step S73—manually by the user 14 or by the control device 2—until the user 14 inputs the confirmation.

After the confirmation has been input, in a step S74 the contrast medium is injected into the vascular system—automatically by the control device 2 or manually by the user 14. The control device 2 then waits in a step S75 for the input of the value numeral (TIMI grade) and reviews this input in a step S76.

If the value numeral input lies in a pre-specified value range (e.g. TIMI grade 1 and below), the control device 2 archives the input value numeral as well as the last recorded preliminary image in a step S77.

If, on the other hand, the value numeral input lies outside this value range (e.g. TIMI grade 2 and above), the control device 2 receives in a step S78 firstly a selection of the section 19. This selection was already described in detail hereinabove in relation to FIG. 2 and does not therefore have to be repeated at this point.

In an optional step S79, the control device 2 then determines the length l of the selected section 19. This determination of length can be carried out e.g. in such a manner as has likewise already been described hereinabove in relation to FIG. 2. Other methods for determining length are, however, also possible.

Next, in a step S80, the recording of the sequence of images Bi and of their recording times ti is started. Thereafter, in a step S81, the contrast medium is injected and in a step S82 the recording of the sequence of images Bi and their recording times ti is ended. Steps S80 to S82 are of course—in an analogous manner to steps S8 to S14 from FIG. 2—executed at an adequate time interval from one another.

Then—in an analogous manner to steps S15 to S22 from FIG. 2—in a step S83 the start image and the stop image are determined and from them—possibly in connection with the length l of the selected section 19—a statement concerning the flow velocity v of the blood in the selected section 19 is made. With the aid of this statement, the control device 2 then determines in a step S84 a new value numeral (TIMI grade) and assigns this value numeral to the selected section 19. In a step S85, it then archives the recorded sequence of images Bi as well as the value numeral re-determined by the control device 2.

The procedure according to the invention is particularly advantageous if it is executed repeatedly and the results of each execution are archived, separately or together. For example, the inventive procedure can be executed once before and once after a therapy carried out on the object 9. In this way, in particular, any therapy result can be documented with objective criteria.

1-22. (canceled)

23. A method for calculating a flow velocity of a fluid in a vascular system, comprising:
pre-specifying a data set to a computer that describes the vascular system in three dimensions;
selecting a section of the vascular system that has a start and an end;
calculating a length of the selected section via the data set;
pre-specifying to the computer a sequence of images of the vascular system;
assigning a point in time to each image;
selecting an image of the sequence of images as a start image and an image of the sequence of images as a stop image;
calculating the flow velocity from the length of the selected section and the points in time assigned to the start image and the stop image; and
outputting the blood flow velocity together with the selected section to a user.

24. The method as claimed in claim 23, wherein the start is pre-specified to the computer by the user.

25. The method as claimed in claim 23, wherein the end is automatically determined by the computer.

26. The method as claimed in claim 23, wherein the end is pre-specified to the computer by the user.

27. The method as claimed in claim 23, wherein the computer is connected to a recording arrangement for recording images of the vascular system and automatically activates the recording arrangement to record the selected section.

28. The method as claimed in claim 23, wherein the computer is connected to a recording arrangement for recording images of the vascular system and pre-specifies instructions to the user to adjust the recording arrangement to record the selected section.

29. The method as claimed in claim 23, wherein the computer determines a color assigned to the velocity and represents the selected section in this color on a display device.

30. The method as claimed in claim 23, wherein the sequence of images shows an entry of a contrast medium into the selected section and a washout of the contrast medium of the selected section.

31. The method as claimed in claim 23, wherein the start image and the stop image are selected by the user.

32. The method as claimed in claim 23, wherein the start image and the stop image are selected automatically by the computer.

33. The operating method as claimed in claim 23,
wherein the computer determines a start cross section which the contrast medium occupies at the start of the selected section and an end cross section which the contrast medium occupies at the end of the selected section for each image of the sequence,
wherein the computer assigns the start cross section and the end cross section to the images so that the start image is determined based on the start cross section and the stop image is determined based on the end cross section.

34. The operating method as claimed in claim 23, wherein the start and stop images are selected when the start and end cross sections cease to increase.

35. The operating method as claimed in claim 23, wherein the start and stop images are selected when the start and end cross sections decreases.

36. The operating method as claimed in claim 23, wherein the computer determines a start line located at a right angle relative to the selected section at the start of the selected section and an end line located at a right angle relative to the selected section at the end of the selected section so that the start cross section is determined using the start line and the end cross section is determined using the end cross line.

37. The operating method as claimed in claim 23, wherein the data set describing the vascular system in three dimensions consists of a plurality of projections of the vascular system which are recorded in a same phase of the vascular system.

38. The operating method as claimed in claim 23, wherein the data set describing the vascular system in three dimensions is a volumetric data set.

39. A method for operating a medical imaging system, comprising:
receiving a selection of a section of a vascular system from a user;
adjusting positions of a recording arrangement to record the selected section;
receiving a preliminary image of the selected section from the recording arrangement;
outputting the preliminary image of the selected section to the user via a display device;
waiting for an input of a value numeral by the user;
archiving the value numeral and the preliminary image if the value numeral lies in a predefined range of values;
recording a sequence of images and the recording times thereof if the value numeral lies outside of the predefined range of values; and
archiving the sequence of images,
wherein the images show the through-flow of a fluid through the selected section.

40. The method as claimed in claim 38, wherein a control device assigns a new value numeral to the selected section and archives the value numeral together with the sequence of images.

41. The method as claimed in claim 38, wherein the control device automatically determines a length of the selected section and the flow velocity of the fluid from the length of the selected section and recording time difference between two images.

42. A medical imaging system, comprising:
a recording device that records images of a vascular system;
a data set that describes the vascular system in three dimensions;
a calculator that calculates a length of a selected section of the vascular system via the data set;
a computer that determines a flow velocity of a fluid of the vascular system;
a display device that displays the flow velocity together with the selected section of the vascular system to a user; and
a storage device that archives the images of the vascular system.
